(19) United States
(12) Patent Application Publication
(10) Pub. No.: US 2026/0099698 A1
(43) Pub. Date: Apr. 9, 2026

(54) SYSTEM AND METHOD FOR MULTIMODAL RETRIEVAL AUGMENTED GENERATION FOR VISUALLY RICH DOCUMENTS

(71) Applicant: JPMorgan Chase Bank, N.A., New York, NY (US)

(72) Inventors: Simerjot KAUR, Jersey City, NJ (US); Zhiqiang MA, Short Hills, NJ (US); Mathieu SIBUE, New York, NY (US); Farima FARMAHINIFARAHANI, Santa Clara, CA (US); Lawrence YONG, Harrison, NJ (US); Dongsheng WANG, London (GB); Armineh NOURBAKHSH, Pittsburgh, PA (US); Lucas CECCHI, New York, NY (US)

(73) Assignee: JPMorgan Chase Bank, N.A., New York, NY (US)

(21) Appl. No.: 18/906,898

(22) Filed: Oct. 4, 2024

(51) Int. Cl. G06N 3/0455; G06F 16/93; G06F 40/289; G06F 40/30

(52) U.S. Cl. CPC G06N 3/0455; G06F 16/93; G06F 40/289; G06F 40/30

(57) ABSTRACT

Various methods and processes, apparatuses/systems, and media for multimodal retrieval augmented generation for visually rich documents are disclosed. A processor implements a page-wise chunking algorithm to chunk a visual document into a plurality of page chunks; inputs the plurality of page chunks onto a trained embedding model; generates one vector for each page chunk. Each vector represents corresponding text, spatial and visual feature of each page of the visual document; inputs, in response to receiving a prompt of a query corresponding to the visual document, the vectors of the embedded chucks of pages retrieved from the database; identifies most relevant chunks of pages based on the similarities between the query prompt and chucks of pages; and generates, in response to inputting the most relevant chunks of pages onto a generative model, a response to the prompt corresponding to the visual document based on the identified most relevant chunks of pages.

### TECHNICAL FIELD

This disclosure generally relates to data processing, and, more particularly, to methods and apparatuses for implementing a platform, language, cloud, and database agnostic multimodal Retrieval Augmented Generation (RAG) module configured to implement multimodal document Artificial Intelligence (AI) and Large Language Models (LLMs) to generate contents based on custom data for visual documents thereby preserving spatial and visual features.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

Conventional techniques may have the ability of LLMs to generate content based on custom data. However, when these techniques are applied to custom visual documents, the use of linear text chunking or image-only chunking and retrieval may present notable limitations, including the loss of spatial and visual features.

For example, current embedding models are predominantly text-based. These models typically undergo an initial pre-training phase using billions of weakly-supervised text pairs across multiple stages, followed by fine-tuning with a smaller set of labeled datasets.

Another conventional approach typically leverages LLMs to generate a diverse array of synthetic datasets for various text embedding tasks, covering approximately a large number of languages. This conventional approach may then fine-tune publicly available decoder-only LLMs using these synthetic datasets, employing a conventional contrastive loss technique. Specifically, a token may be appended to an end of a query and document during training to capture hidden semantics, which may be subsequently used to calculate a contrastive loss. These models may be fine-tuned on multiple downstream tasks, further enhancing their performance and versatility. While these conventional models may excel in text-based tasks, they do not adequately capture the spatial and visual features inherent in visual documents.

Yet another conventional model may integrate generative and embedding tasks through instructional prompts. For embedding tasks, this conventional model may process the input using bidirectional attention and then may apply mean pooling to the last hidden state to obtain a final representation. Again, this conventional approach to embedding tasks, although may be effective for text, lacks the multimodal capabilities required for complex document formats.

Moreover, conventional multi-modal retrieval technique may introduce a multi-modal representation that incorporates both text and vision to encode documents. By utilizing multi-dimensional embeddings, this conventional multi-modal retrieval technique may capture finer-grained relevance between queries and documents, particularly focusing on image datasets. Although this conventional multi-modal retrieval technique may be effective for image-centric tasks, may fall short in scenarios where the spatial arrangement and contextual relationship between text and images are crucial.

### SUMMARY

The present disclosure, through one or more of its various aspects, embodiments, and/or specific features or sub-components, provides, among other features, various systems, servers, devices, methods, media, programs, and platforms for implementing a platform, language, cloud, and database agnostic multimodal retrieval augmented generation module configured to implement multimodal document artificial AI and LLMs to dynamically and automatically generate contents based on custom data for visual documents thereby preserving spatial and visual features, but the disclosure is not limited thereto.

In some embodiments, the present disclosure, through one or more of its various aspects, embodiments, and/or specific features or sub-components, also provides, among other features, various systems, servers, devices, methods, media, programs, and platforms for implementing a platform, language, cloud, and database agnostic multimodal retrieval augmented generation module configured to streamline an indexing process by leveraging multimodal document AI models, thereby reducing the extensive preprocessing typically required for visual documents. To preserve the multimodal semantics across pages of various formats, the multimodal retrieval augmented generation module may be configured to employ page-wise chunking, enhancing compatibility with document AI LLMs, but the disclosure is not limited thereto.

In some embodiments, a method for multimodal retrieval augmented generation for visual documents having spatial and visual features by utilizing one or more processors along with allocated memory is disclosed. The method may include: receiving, as input, a visual document having a plurality of texts, spatial, and visual features; implementing a page-wise chunking algorithm to chunk the visual document into a plurality of page chunks; inputting the plurality of page chunks onto a trained embedding model; generating, by the embedding model, one vector for each page chunk in response to inputting the plurality of page chunks onto the embedding model, wherein each vector represents corresponding text, spatial and visual feature of each page of the visual document; storing all vectors corresponding to the plurality of the page chunks onto a database; inputting, in response to receiving a prompt of a query corresponding to the visual document, the vectors of the embedded chucks of pages retrieved from the database; identifying most relevant chunks of pages included in the visual document based on the similarities between the query prompt and chucks of pages; and generating, in response to inputting the most relevant chunks of pages onto a generative model, a response to the prompt corresponding to the visual document based on identified most relevant chunks of pages.

In some embodiments, the generative model may be a trained prompt generation model that utilizes a pre-trained autoregressive LLM, but the disclosure is not limited thereto.

In some embodiments, in generating the response to the prompt, the method may further include: using the trained prompt-generation model to generate query space for each page chunk from the plurality page chunks; capturing a semantic essence of the prompt by implementing an alignment learning algorithm utilizing an autoencoder; and outputting a response to the prompt corresponding to the captured semantic essence given the context of most relevant chunks of pages. In some embodiments, the query may include, for example, name of a customer, location of a customer, certain company name, how much money the customer spends on this check, or prompts that require “Yes” or “No” responses, etc., but the disclosure is not limited thereto.

In some embodiments, the method may further include: fine-tuning the prompt-generation model by training the prompt-generation model that maximizes log-likelihood of correctly predicting a next token in the sequence of tokens from the prompt, given a context of document page tokens.

In some embodiments, in capturing the semantic essence of the prompt, the method may further include: fine-tuning an autoencoder to encode the prompt by using contrastive learning objective; and obtaining the prompt vector representation of the first special pooling token as the output from the autoencoder corresponding to the prompt

In some embodiments, the method may further include identifying most relevant chunks included in the visual document based on the vectors by applying a cosine similarity algorithm, wherein a distance between two vectors may measure their relatedness in a manner such that small distances correspond to high relatedness and large distances correspond to low relatedness.

In some embodiments, the method may further include ranking most relevant chunks of pages that correspond to high relatedness.

In some embodiments, a system for multimodal retrieval augmented generation for visual documents having spatial and visual features is disclosed. The system may include: a processor; and a memory operatively connected to the processor via a communication interface, the memory storing computer readable instructions, when executed, may cause the processor to: receive, as input, a visual document having a plurality of texts, spatial and visual features; implement a page-wise chunking algorithm to chunk the visual document into a plurality of page chunks; input the plurality of page chunks onto a trained embedding model; generate, by the embedding model, one vector for each page chunk in response to inputting the plurality of page chunks onto the embedding model, wherein each vector represents corresponding text, spatial, and visual feature of each page of the visual document; store all vectors corresponding to the plurality of the page chunks onto a database; input, in response to receiving a prompt of a query corresponding to the visual document, the vectors of the embedded chucks of pages retrieved from the database; identify most relevant chunks of pages included in the visual document based on the similarities between the query prompt and chucks of pages; and generate, in response to inputting the most relevant chunks of pages onto a generative model, a response to the prompt corresponding to the visual document based on identified most relevant chunks of pages. In some embodiments, the generative model may be a trained prompt generation model that utilizes a pre-trained autoregressive LLM, but the disclosure is not limited thereto.

In some embodiments, in generating the response to the prompt, the processor may be further configured to: using the trained prompt-generation model to generate query space for each page chunk from the plurality page chunks; capturing a semantic essence of the prompt by implementing an alignment learning algorithm utilizing an autoencoder; and outputting a response to the prompt corresponding to the captured semantic essence.

In some embodiments, the processor may be further configured to: fine-tune the prompt-generation model by training the prompt-generation model that maximizes log-likelihood of correctly predicting a next token in the sequence of tokens from the prompt, given a context of document page tokens.

In some embodiments, in capturing the semantic essence of the prompt, the processor may be further configured to: fine-tune an autoencoder to encode prompt by using contrastive learning objective; and obtain the prompt vector representation of the first special pooling token output from the autoencoder corresponding to the prompt.

In some embodiments, the processor may be further configured to: identify most relevant chunks included in the visual document based on the vectors by applying a cosine similarity algorithm, wherein a distance between two vectors may measure their relatedness in a manner such that small distances correspond to high relatedness and large distances correspond to low relatedness.

In some embodiments, the processor may be further configured to rank the most relevant chunks of pages that correspond to high relatedness.

In some embodiments, a non-transitory computer readable medium configured to store instructions for multimodal retrieval augmented generation for visual documents having spatial and visual features is disclosed. The instructions, when executed, may cause a processor to perform the following: receiving, as input, a visual document having a plurality of texts, spatial and visual features; implementing a page-wise chunking algorithm to chunk the visual document into a plurality of page chunks; inputting the plurality of page chunks onto a trained embedding model; generating, by the embedding model, one vector for each page chunk in response to inputting the plurality of page chunks onto the embedding model, wherein each vector represents corresponding text, spatial and visual feature of each page of the visual document; storing all vectors corresponding to the plurality of the page chunks onto a database; inputting, in response to receiving a prompt of a query corresponding to the visual document, the vectors of the embedded chucks of pages retrieved from the database; identifying most relevant chunks of pages included in the visual document based on the similarities between the query prompt and chucks of pages; and generating, in response to inputting the most relevant chunks of pages onto a generative model, a response to the prompt corresponding to the visual document based on identified most relevant chunks of pages.

In some embodiments, in generating the response to the prompt, the instructions, when executed, may cause the processor to further perform the following: use the trained prompt-generation model to generate query space for each page chunk from the plurality page chunks; capturing a semantic essence of the prompt by implementing an alignment learning algorithm utilizing an autoencoder; and outputting a response to the prompt corresponding to the captured semantic essence given the context of most relevant chunks of pages. In some embodiments, the query may include, for example, name of a customer, location of a customer, certain company name, how much money the customer spends on this check, or prompts that require “Yes” or “No” responses, etc., but the disclosure is not limited thereto.

In some embodiments, the instructions, when executed, may cause the processor to further perform the following: fine-tuning the prompt-generation model by training the prompt-generation model that maximizes log-likelihood of correctly predicting a next token in the sequence of tokens from the prompt, given a context of document page tokens.

In some embodiments, in capturing the semantic essence of the prompt, the instructions, when executed, may cause the processor to further perform the following: fine-tuning an autoencoder to encode prompt by using contrastive learning objective; and obtaining the prompt vector representation of the first special pooling token output from the autoencoder corresponding to the prompt.

In some embodiments, the instructions, when executed, may cause the processor to further perform the following: identifying most relevant chunks included in the visual document based on the vectors by applying a cosine similarity algorithm, wherein a distance between two vectors may measure their relatedness in a manner such that small distances correspond to high relatedness and large distances correspond to low relatedness.

In some embodiments, the instructions, when executed, may cause the processor to further perform the following: ranking most relevant chunks of pages that correspond to high relatedness.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a platform, language, database, and cloud agnostic multimodal retrieval augmented generation module configured to implement multimodal document artificial AI and LLMs to dynamically and automatically generate contents based on custom data for visual documents in accordance with an embodiment.

FIG. 2 illustrates a diagram of a network environment with a platform, language, database, and cloud agnostic multimodal retrieval augmented generation device in accordance with an embodiment.

FIG. 3 illustrates a system diagram for implementing a platform, language, database, and cloud agnostic multimodal retrieval augmented generation device having a platform, language, database, and cloud agnostic multimodal retrieval augmented generation module in accordance with an embodiment.

FIG. 4 illustrates a system diagram for implementing a platform, language, database, and cloud agnostic multimodal retrieval augmented generation module of FIG. 3 in accordance with an embodiment.

FIG. 5 illustrates a flow chart of a process implemented by the platform, language, database, and cloud agnostic multimodal retrieval augmented generation module of FIG. 4 for implementing multimodal document artificial AI and LLMs to dynamically and automatically generate contents based on custom data for visual documents in accordance with an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in may include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

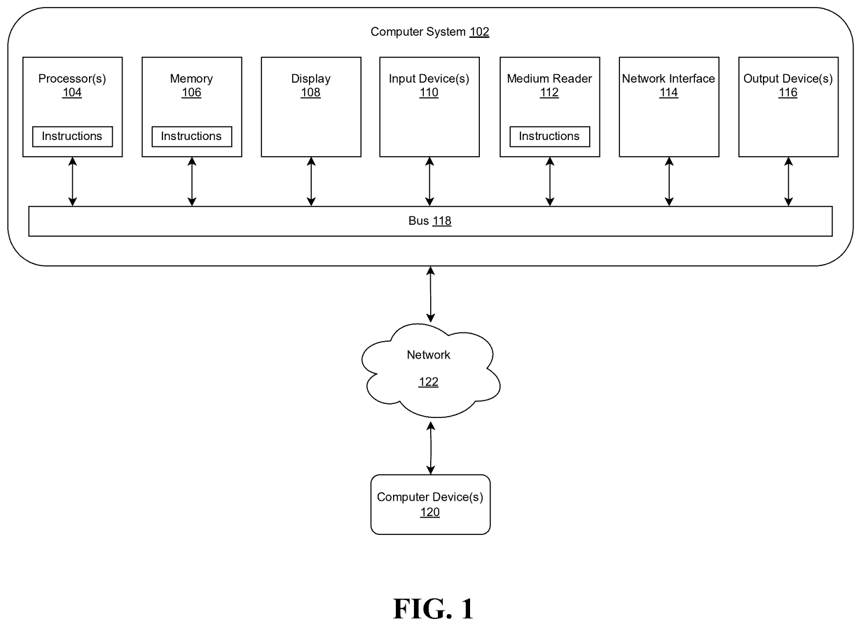

FIG. 1 is an exemplary system 100 for use in implementing a platform, language, database, and cloud agnostic multimodal retrieval augmented generation module configured to implement multimodal document artificial AI and LLMs to dynamically and automatically generate contents based on custom data for visual documents in accordance with an exemplary embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. In some embodiments, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 may be tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 may be an article of manufacture and/or a machine component. The processor 104 may be configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that may store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which may be configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, in some embodiments, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that may be capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. In some embodiments, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the multimodal retrieval augmented generation module may be platform, language, database, and cloud agnostic that may allow for consistent easy orchestration and passing of data through various components to output a desired result regardless of platform, browser, language, database, and cloud environment. Since the disclosed process, in some embodiments, may be platform, language, database, browser, and cloud agnostic, the multimodal retrieval augmented generation module may be independently tuned or modified for optimal performance without affecting the configuration or data files. The configuration or data files, in some embodiments, may be written using JSON, but the disclosure is not limited thereto. In some embodiments, the configuration or data files may easily be extended to other readable file formats such as XML, YAML, etc., or any other configuration based languages.

In accordance with various embodiments of the present disclosure, the methods described herein may be implemented using a hardware computer system that executes software programs. Further, in an exemplary, non-limited embodiment, implementations may include distributed processing, component/object distributed processing, and an operation mode having parallel processing capabilities. Virtual computer system processing may be constructed to implement one or more of the methods or functionality as described herein, and a processor described herein may be used to support a virtual processing environment.

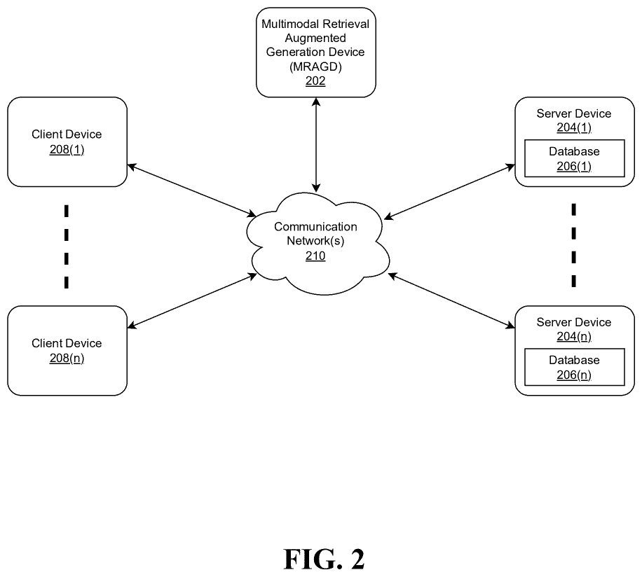

Referring to FIG. 2, a schematic of an exemplary network environment 200 for implementing a language, platform, database, and cloud agnostic multimodal retrieval augmented generation device (MRAGD) of the instant disclosure is illustrated.

In some embodiments, the above-described problems associated with conventional tools may be overcome by implementing an MRAGD 202 as illustrated in FIG. 2 that may be configured for implementing a platform, language, database, and cloud agnostic multimodal retrieval augmented generation module configured to implement multimodal document artificial AI and LLMs to dynamically and automatically generate contents based on custom data for visual documents thereby preserving spatial and visual features, but the disclosure is not limited thereto.

The MRAGD 202 may have one or more computer system 102s, as described with respect to FIG. 1, which in aggregate provide the necessary functions.

The MRAGD 202 may store one or more applications that may include executable instructions that, when executed by the MRAGD 202, cause the MRAGD 202 to perform actions, such as to transmit, receive, or otherwise process network messages, in some embodiments, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the MRAGD 202 itself, may be located in virtual server(s) running in a cloud-based computing environment rather than being tied to one or more specific physical network computing devices. Also, the application(s) may be running in one or more virtual machines (VMs) executing on the MRAGD 202. Additionally, in one or more embodiments of this technology, virtual machine(s) running on the MRAGD 202 may be managed or supervised by a hypervisor.

In the network environment 200 of FIG. 2, the MRAGD 202 may be coupled to a plurality of server devices 204(1)-204(n) that hosts a plurality of databases 206(1)-206(n), and also to a plurality of client devices 208(1)-208(n) via communication network(s) 210. A communication interface of the MRAGD 202, such as the network interface 114 of the computer system 102 of FIG. 1, operatively couples and communicates between the MRAGD 202, the server devices 204(1)-204(n), and/or the client devices 208(1)-208(n), which may all be coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the MRAGD 202, the server devices 204(1)-204(n), and/or the client devices 208(1)-208(n) may be coupled together via other topologies. Additionally, the network environment 200 may include other network devices such as one or more routers and/or switches, in some embodiments, which are well known in the art and thus will not be described herein.

By way of example only, the communication network(s) 210 may include local area network(s) (LAN(s)) or wide area network(s) (WAN(s)), and may use TCP/IP over Ethernet and industry-standard protocols, although other types and/or numbers of protocols and/or communication networks may be used. The communication network(s) 210 in this example may employ any suitable interface mechanisms and network communication technologies including, in some embodiments, teletraffic in any suitable form (e.g., voice, modem, and the like), Public Switched Telephone Network (PSTNs), Ethernet-based Packet Data Networks (PDNs), combinations thereof, and the like.

The MRAGD 202 may be a standalone device or integrated with one or more other devices or apparatuses, such as one or more of the server devices 204(1)-204(n). In some embodiments, the MRAGD 202 may be hosted by one of the server devices 204(1)-204(n), and other arrangements may also be possible. Moreover, one or more of the devices of the MRAGD 202 may be in the same or a different communication network including one or more public, private, or cloud networks, in some embodiments.

The plurality of server devices 204(1)-204(n) may be the same or similar to the computer system 102 or the computer device 120 as described with respect to FIG. 1, including any features or combination of features described with respect thereto. In some embodiments, any of the server devices 204(1)-204(n) may include, among other features, one or more processors, a memory, and a communication interface, which may be coupled together by a bus or other communication link, although other numbers and/or types of network devices may be used. The server devices 204(1)-204(n) in this example may process requests received from the MRAGD 202 via the communication network(s) 210 according to the HTTP-based and/or JavaScript Object Notation (JSON) protocol, in some embodiments, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that may be configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

In some embodiments, the server devices 204(1)-204(n) may operate as a plurality of network computing devices within a cluster architecture, a peer-to peer architecture, virtual machines, or within a cloud architecture. Thus, the technology disclosed herein is not to be construed as being limited to a single environment and other configurations and architectures may also be envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that may facilitate the implementation of the MRAGD 202 that may efficiently provide a platform for implementing a platform, language, database, and cloud agnostic multimodal retrieval augmented generation module configured to implement multimodal document artificial AI and LLMs to dynamically and automatically generate contents based on custom data for visual documents thereby preserving spatial and visual features, but the disclosure is not limited thereto.

The client devices 208(1)-208(n) may run interface applications, such as standard web browsers or standalone client applications, which may provide an interface to communicate with the MRAGD 202 via the communication network(s) 210 in order to communicate user requests. The client devices 208(1)-208(n) may further include, among other features, a display device, such as a display screen or touchscreen, and/or an input device, such as a keyboard, in some embodiments.

Although the exemplary network environment 200 with the MRAGD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the MRAGD 202, the server devices 204(1)-204(n), or the client devices 208(1)-208(n), in some embodiments, may be configured to operate as virtual instances on the same physical machine. In some embodiments, one or more of the MRAGD 202, the server devices 204(1)-204(n), or the client devices 208(1)-208(n) may operate on the same physical device rather than as separate devices communicating through communication network(s) 210. Additionally, there may be more or fewer MRAGDs 202, server devices 204(1)-204(n), or client devices 208(1)-208(n) than illustrated in FIG. 2. In some embodiments, the MRAGD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

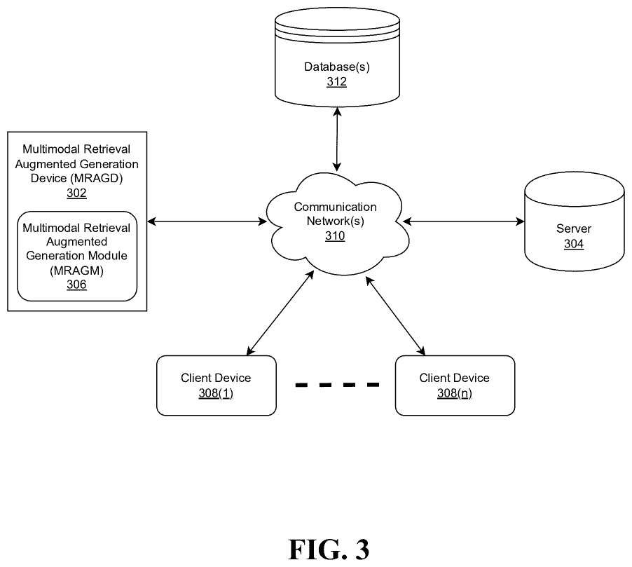

FIG. 3 illustrates a system diagram for implementing a platform, language, and cloud agnostic MRAGD having a platform, language, database, and cloud agnostic multimodal retrieval augmented generation module (MRAGM) in accordance with an embodiment.

As illustrated in FIG. 3, the system 300 may include an MRAGD 302 within which an MRAGM 306 may be embedded, a server 304, a database(s) 312, a plurality of client devices 308(1) . . . 308(n), and a communication network 310.

In some embodiments, the MRAGD 302 including the MRAGM 306 may be connected to the server 304, and the database(s) 312 via the communication network 310. The MRAGD 302 may also be connected to the plurality of client devices 308(1) . . . 308(n) via the communication network 310, but the disclosure is not limited thereto.

According to exemplary embodiment, the MRAGD 302 is described and shown in FIG. 3 as including the MRAGM 306, although it may include other rules, policies, modules, databases, or applications, etc. In some embodiments, the database(s) 312 may be configured to store ready to use modules written for each Application Programming Interface (API) for all environments. Although only one database is illustrated in FIG. 3, the disclosure is not limited thereto. Any number of desired databases may be utilized for use in the disclosed invention herein. The database(s) 312 may be a mainframe database, a log database that may produce programming for searching, monitoring, and analyzing machine-generated data via a web interface, etc., but the disclosure is not limited thereto. In addition, the database(s) 312 may store the large code bases models as directed graphs and graph metrics and graph centrality measures.

In some embodiments, the MRAGM 306 may be configured to receive real-time feed of data from the plurality of client devices 308(1) . . . 308(n) and secondary sources via the communication network 310.

As may be described below, the MRAGM 306 may be configured to: receive, as input, a visual document having a plurality of spatial and visual features; implement a page-wise chunking algorithm to chunk the visual document into a plurality of page chunks; input the plurality of page chunks onto an embedding model; generate, by the embedding model, one vector for each page chunk in response to inputting the plurality of page chunks onto the embedding model, wherein each vector represents corresponding spatial and visual feature of the visual document; store all vectors corresponding to the plurality of the page chunks onto a database; identify most relevant chunks of pages included in the visual document based on the vectors and storing the most relevant chunks of pages onto the database; input, in response to receiving a prompt corresponding to the visual document, the most relevant chunks of pages retrieved from the database onto a pre-trained prompt-generation model that utilizes a pre-trained autoregressive language model; and generate, in response to inputting the most relevant chunks of pages onto the pre-trained prompt-generation model, a response to the prompt corresponding to the visual document based on identified most relevant chunks of pages, but the disclosure is not limited thereto.

The plurality of client devices 308(1) . . . 308(n) are illustrated as being in communication with the MRAGD 302. In this regard, the plurality of client devices 308(1) . . . 308(n) may be “clients” (e.g., customers) of the MRAGD 302 and are described herein as such. Nevertheless, it is to be known and understood that the plurality of client devices 308(1) . . . 308(n) need not necessarily be “clients” of the MRAGD 302, or any entity described in association therewith herein. Any additional or alternative relationship may exist between either or both of the plurality of client devices 308(1) . . . 308(n) and the MRAGD 302, or no relationship may exist.

The first client device 308(1) may be, in some embodiments, a smart phone. Of course, the first client device 308(1) may be any additional device described herein. The second client device 308(n) may be, in some embodiments, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. In an embodiment, one or more of the plurality of client devices 308(1) . . . 308(n) may communicate with the MRAGD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The MRAGD 302 may be the same or similar to the MRAGD 202 as described with respect to FIG. 2, including any features or combination of features described with respect thereto.

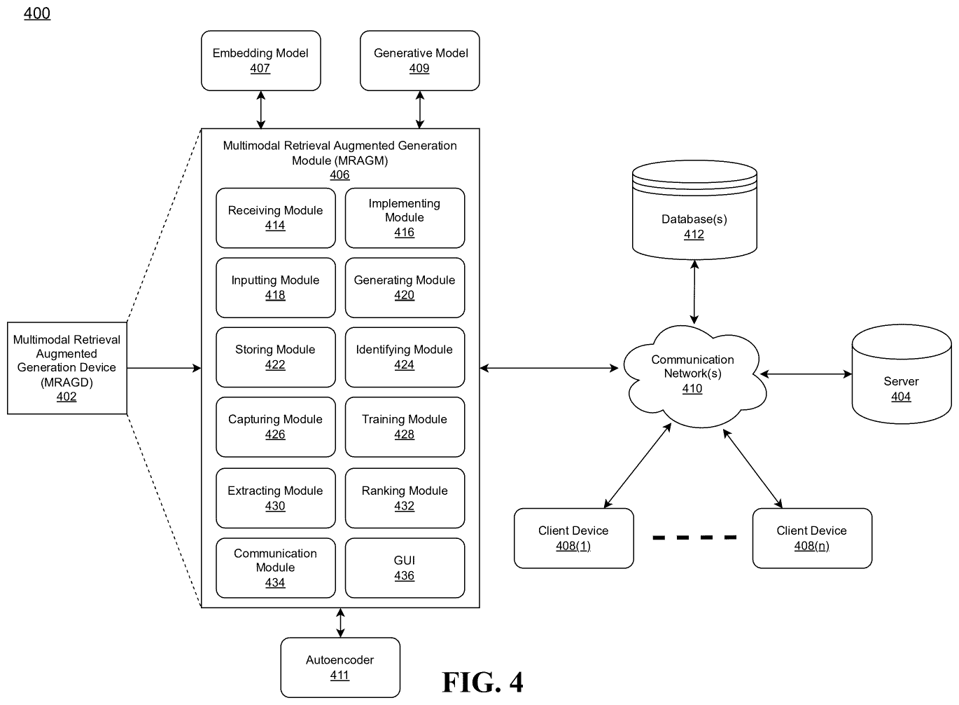

FIG. 4 illustrates a system diagram for implementing a platform, language, database, and cloud agnostic MRAGM of FIG. 3 in accordance with an exemplary embodiment.

In some embodiments, the system 400 may include a platform, language, database, and cloud agnostic MRAGD 402 within which a platform, language, database, and cloud agnostic MRAGM 406 may be embedded, a server 404, database(s) 412, a pre-trained embedding model 407, a generative model 409 (i.e., a pre-trained prompt-generation model that utilizes an LLM), and a communication network 410. In some embodiments, server 404 may comprise a plurality of servers located centrally or located in different locations, but the disclosure is not limited thereto.

In some embodiments, the MRAGD 402 including the MRAGM 406 may be connected to the server 404, the embedding model 407, the generative model 409, and the database(s) 412 via the communication network 410. The MRAGD 402 may also be connected to the plurality of client devices 408(1)-408(n) via the communication network 410, but the disclosure is not limited thereto. The MRAGM 406, the server 404, the plurality of client devices 408(1)-408(n), the database(s) 412, the communication network 410 as illustrated in FIG. 4 may be the same or similar to the MRAGM 306, the server 304, the plurality of client devices 308(1)-308(n), the database(s) 312, the communication network 310, respectively, as illustrated in FIG. 3.

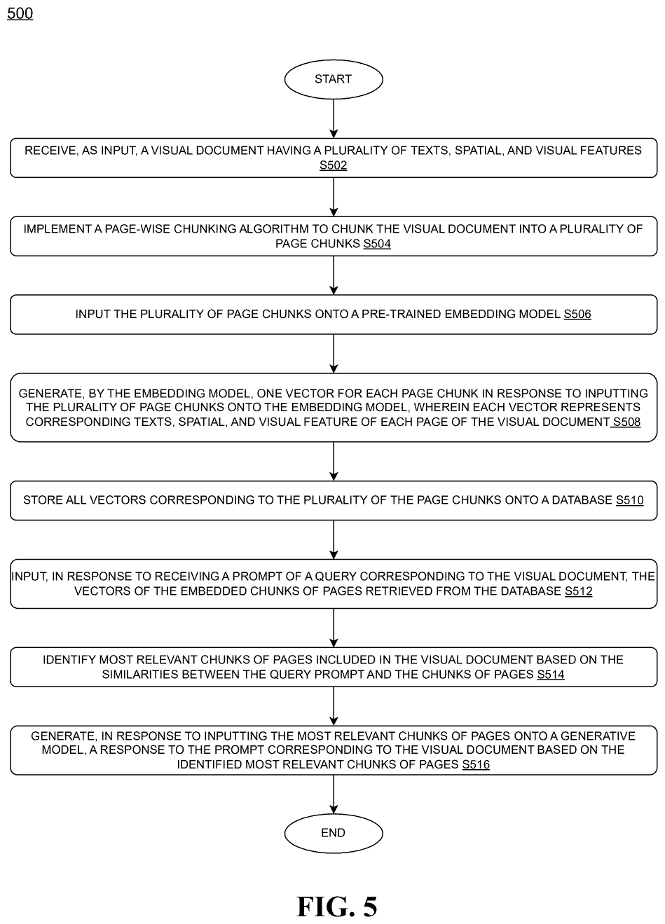

In some embodiments, as illustrated in FIG. 4, the MRAGM 406 may include a receiving module 414, an implementing module 416, an inputting module 418, a generating module 420, a storing module 422, an identifying module 424, a capturing module 426, a training module 428, an extracting module 430, a ranking module 432, a communication module 434, and Graphical User Interface (GUI) 436. In some embodiments, interactions and data exchange among these modules included in the MRAGM 406 provide the advantageous effects of the disclosed invention. Functionalities of each module of FIG. 4 may be described in detail below with reference to FIGS. 4-5.

In some embodiments, each of the receiving module 414, implementing module 416, inputting module 418, generating module 420, storing module 422, identifying module 424, capturing module 426, training module 428, extracting module 430, ranking module 432, and the communication module 434 of the MRAGM 406 of FIG. 4 may be physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies.

In some embodiments, each of the receiving module 414, implementing module 416, inputting module 418, generating module 420, storing module 422, identifying module 424, capturing module 426, training module 428, extracting module 430, ranking module 432, and the communication module 434 of the MRAGM 406 of FIG. 4 may be implemented by microprocessors or similar, and may be programmed using software (e.g., microcode) to perform various functions discussed herein and may optionally be driven by firmware and/or software.

Alternatively, in some embodiments, receiving module 414, implementing module 416, inputting module 418, generating module 420, storing module 422, identifying module 424, capturing module 426, training module 428, extracting module 430, ranking module 432, and the communication module 434 of the MRAGM 406 of FIG. 4 may be implemented by dedicated hardware, or as a combination of dedicated hardware to perform some functions and a processor (e.g., one or more programmed microprocessors and associated circuitry) to perform other functions, but the disclosure is not limited thereto. In some embodiments, the MRAGM 406 of FIG. 4 may also be implemented by Cloud based deployment.

In some embodiments, each of receiving module 414, implementing module 416, inputting module 418, generating module 420, storing module 422, identifying module 424, capturing module 426, training module 428, extracting module 430, ranking module 432, and the communication module 434 of the MRAGM 406 of FIG. 4 may be called via corresponding API, but the disclosure is not limited thereto. In some embodiments, the receiving module 414 may be called via a first API, the implementing module 416 may be called via a second API, the inputting module 418 may be called via a third API, the generating module 420 may be called via a fourth API, the storing module 422 may be called via a fifth API, the identifying module 424 may be called via a sixth API, the capturing module 426 may be called via a seventh API, the training module 428 may be called via an eighth API, the extracting module 430 may be called via a ninth API, the ranking module 432 may be called via a tenth API, and the communication module 434 may be called via an eleventh API, but the disclosure is not limited thereto. In some embodiments, calls may also be made using event based message interfaces in addition to APIs.

In some embodiments, the process implemented by the MRAGM 406 may be executed via the communication module 434, and the communication network 410, which may comprise plural networks as described above. In some embodiments, in an exemplary embodiment, the various components of the MRAGM 406 may communicate with the server 404, the embedding model 407, the generative model 409 (may also be referred to herein as prompt-generation model 409), and the database(s) 412 via the communication module 434 and the communication network 410 and the results may be displayed onto the GUI 436. Of course, these embodiments are merely exemplary and are not limiting or exhaustive. The database(s) 412 may include the databases included within the private cloud and/or public cloud and the server 404 may include one or more servers within the private cloud and the public cloud.

In some embodiments, the MRAGM 406 may be configured to implement multimodal document AI and LLMs to dynamically and automatically generate contents based on custom data for visual documents thereby preserving spatial and visual features via the interactions of each module embedded within the MRAGM 406, but the disclosure is not limited thereto. In some embodiments, the MRAGM 406 may be configured to streamline an indexing process by leveraging multimodal document AI models, thereby reducing the extensive preprocessing typically required for visual documents. To preserve the multimodal semantics across pages of various formats, the MRAGM 406 may be configured to employ page-wise chunking, enhancing compatibility with document AI LLMs, but the disclosure is not limited thereto.

For example, in the context of data processing, the MRGAM 406 may be configured to differentiate between two principal chunking methodologies: window-based (or fixed-length) chunking with overlap, and page-wise chunking capable of accommodating multiple modalities, including text, spatial, and vision data. Let D denote the dataset or document subjected to chunking.

Window-chunking: it is defined as windowSplitter(D, l, o), where l represents the chunk length and o the overlap between chunks, this method produces a sequence of text chunks:

$$\{ {T}_{1} , {T}_{2} , … , {T}_{k} \} = windowSplitter ( D , l , o ) ,$$

where Tᵢ stands for text chunk, a sequence of text.

Page-chunking (image): For vision-based chunking specifically, visPageSplitter(D) focuses on vision features per page:

$$\{ {I}_{1} , {I}_{2} , … , {I}_{k} \} = v i s PageSplitter ( D ) ,$$

where Iᵢ stands for a visual chunk.
This formalization underscores the adaptability of chunking strategies to task-specific requirements, including data modality considerations and chunk granularity.

Page-chunking (multimodal): Contrastingly, page-wise chunking is realized through mPageSplitter(D), segmenting D into pages with potential for spatial S, vision I, and text T modalities, yielding:

$$\{ \{ ( {T}_{1} , {S}_{1} , {I}_{1} ) , ( {T}_{2} , {S}_{2} , {I}_{2} ) , … , ( {T}_{p} , {S}_{p} , {I}_{p} ) \} = m m PageSplitter ( D )$$

In some embodiments, each document page chunk i is represented by textual features Tᵢ derived from its textual content, spatial features Sᵢ, and visual features Iᵢ; Sᵢ can be normalized positions of the text token's bounding box (xₘᵢₙ, yₘᵢₙ, xₘₐₓ, yₘₐₓ).

For each page chunk, the MRAGM 406 may be configured to construct embedding vector vᵢ for different modalities by utilizing the embedding model 407. These modalities may capture various aspects of the data, such as text and images.

$$\{ \begin{matrix}{v}_{i}^{I} = Embed ( {I}_{i} ) \\ {v}_{i}^{T} = Embed ( {T}_{i} ) \\ {v}_{i}^{S} = Embed ( {S}_{i} )\end{matrix} \qquad ( 2 )$$

The MRGAM 406 may be configured to generate the embedding of the page i by using the embeddings of the different modalities

$${v}^{P} = f ( {v}^{I} , {v}^{T} , {v}^{S} ) ,$$

where ƒ is the pre-trained prompt-generation model.

In some embodiments, the MRGAM 406 may be configured to define the retrieval score between a candidate chunk and a query prompt as follows:

$$score ( {v}_{i} , {v}_{q} ) = \frac{{v}_{i} \cdot {v}_{q}}{‖ {v}_{i} ‖ ‖ {v}_{q} ‖} \qquad ( 1 )$$

where vᵢ represents the embedding vector of the i-th page chunk, and v_{q} is the embedding vector of the query prompt. The dot product between the two vectors measures the similarity between the two vectors, normalized by the product of their magnitudes to ensure that the score is bounded between −1 and 1.

In some embodiments, the MRAGM 406 may be configured to implement a framework that combines a two-stage learning process aimed at enhancing the interaction between page context and queries. In the first stage, the framework may employ the prompt-generation model 409, utilizing an autoregressive language model like to generate potential query space for a given page chunk, specifically the last token of this page.

In some embodiments, the second stage may introduce an alignment learning mechanism utilizing the autoencoder 411 to capture the semantic essence of the prompts. This stage focuses on the autoencoder's 411 first pooling token. With a training set of queries and pages, a contrastive learning objective may be employed by the MRAGM 406 for updating the autoencoder model. This objective encourages the autoencoder 411 to develop a more robust encoding for query prompts.

In some embodiments, the MRAGM 406 may be configured to minimize the two losses of the above-described framework,

$${ℒ}_{P A G E} = \{ {ℒ}_{Q} , {ℒ}_{c} \} , \qquad ( 4 )$$

where [symbol] _{Q} is the loss of the prompt-generation model and [symbol] _{c} is loss from the contrastive learning.

In some embodiments, the prompt-generation model 409, i.e., a prompt-generative embedding model, may be adjusted to learn query space for each page chunk, based on various datasets. Its training objective may align with traditional autoregressive language models, aiming to maximize the log-likelihood of correctly predicting the next token, given the context of a document page tokens. In some embodiments, the prompt-generation model 409 may be configured to generate a prompt: given a sequence of tokens from a page chunk, ending with a special page token, the prompt-generation model 409 may be trained to predict appropriate prompts based on the content of the page. The formula for this process may be given by:

$${ℒ}_{Q} ( θ ) = - {\sum }_{j = 1}^{{N}_{q}} log {p}_{θ} ( {q}_{j} \vert \tilde{x} , q < j ) \qquad ( 5 )$$

where, \tilde{x} represents the page tokens, and q denotes the query (or prompt) to be predicted. This formulation may encapsulate the prompt-generation model's 409 predictive capability, focusing on generating queries that are contextually relevant to the given document page.

Contrary to the prevalent approach in embedding models that depend on the final tokens of queries and documents, in some embodiments, the MRAGM 406 may be configured to leverage the special pooling token from the autoencoder 411 to extract hidden semantic meanings. Furthermore, the relatively small size of autoencoder models may act as auxiliary layers, enabling efficient and economical fine-tuning.

Dimensional consistency may prove to be vital for accurate cosine similarity calculations between query and document embeddings. Employing mixed models, such as text-based models for prompts and multimodal for documents, may lead to dimensional mismatches. This restricts model selection and compromises the direct applicability of cosine similarity.

To ensure that the model benefits from precise and efficient data access during its generation tasks, the MRAGM 406 may be configured to incorporate learn-to-retrieval, powered by add-on layers, to enhance document understanding. The reason for using add-on layers is that the embedding models could be LLMs, which are usually too expensive to train. Thus, the design implemented by the MRAGM 406 may optimize the retrieval of relevant information chunks with lightweight extension. Specifically, the MRAGM 406 may be configured to employ an additional cross-attention layer that learns with both query projection and chunk projection.

Leveraging contrastive learning, MRAGM 406 may be configured to offer a robust approach to identify the relevant page containing the answer to a given question among multiple pages. This may be achieved by training the model with data that pairs each question (query prompt) with positive examples (pages containing the answer) and negative examples (pages without the answer). The objective may be to learn a function ƒ(⋅) that maps query prompt to a space where distances between the query and the positive examples are smaller than the negative examples.

Triplet Loss may be used by the MRAGM 406 for when there are inconsistent numbers of negative samples:

$$ℒ ( q , p , n ) = max ( sim ( q , p ) - s i m ( q , n ) + α , 0 ) \qquad ( 6 )$$

where q is the query, p is the positive page, n is the negative page, sim(x, y) is a distance function, α is a margin.

InfoNCE Loss may be used by the MRAGM 406 for generic training with sufficient negative samples:

$${ℒ}_{InfoNCE} = - log \frac{exp ( s i m ( q , p / τ )}{{\sum }_{z} exp ( s i m ( q , z ) / τ )} \qquad ( 7 )$$

where q is the query, p is the positive page, and z∈{p, X} represents a sample from a set of pages containing one positive page and several negative pages, sim(x, y) is a similarity function, and τ is a temperature parameter.

In some embodiments, the contrastive learning implemented by the MRAGM 406 may include implementing a negative sampling algorithm where, negative samples may be selected offline.

In some embodiments, the sampling methods may include one or more of the following methods: a baseline method, strategy 1, strategy 2, and strategy 3.

In some embodiments, according to baseline method, to determine negative pages, the MRAGM 406 may use a hyperparameter k. For documents with more than k pages, the MRAGM 406 may randomly select k pages, excluding the positive page. For documents with fewer than k pages, the MRAGM 406 may select all pages except the positive page. In this baseline method, k may be set to a predefined value ranging from 5-30, but the disclosure is not limited thereto. In an embodiment, this predefined value may be 20.

In some embodiments, the strategy 1 methodology implemented by the MRAGM 406 follows the baseline method but adjusts the hyperparameter k to 7, aiming to refine the selection of negative samples.

In some embodiments, in implementing the strategy 2 methodology, the MRAGM 406 may be configured to obtain moderately challenging negative samples. For each document, the MRAGM 406 may calculate similarity scores between the positive page and the other pages. The MRAGM 406 may then select the k pages with the highest similarity scores as negative samples, using k values of 5 and 7.

In some embodiments, in implementing the strategy 3 methodology, the MRAGM 406 may be configured to select negative samples from the entire training dataset. For each query-document pair, the MRAGM 406 may be configured to compute similarity scores between the positive page and all other pages within the same document, as well as pages from other documents across the dataset. The pages may be then ranked, by utilizing the ranking module 432, based on these similarity scores. In some embodiments, pages with scores in the range of [0.4, 0.95] may be used, but the disclosure is not limited thereto. This scoring range may be strategically chosen to ensure that the pages are neither too similar nor too dissimilar to the positive page. If the total number of pages within this score range exceeds 200, the MRAGM 406 may be configured to select the top 200 pages; otherwise, all pages within the range may be selected. Given the selection, the MRAGM 406 may be configured to perform random sampling on this subset to retrieve 10 pages as hard negative samples. This approach may help to effectively balance the challenge posed by the negative samples, enhancing the robustness and effectiveness of the model training process by ensuring a diverse yet appropriately challenging set of negative samples.

Referring back to FIG. 4, in some embodiments, the receiving module 414 may be configured to receive, as input, a visual document having a plurality of texts, spatial, and visual features. The visual document may include invoice, contracts, layouts, tables, charts, etc., but the disclosure is not limited thereto.

In some embodiments, the implementing module 416 may be configured to implement a page-wise chunking algorithm to chunk the visual document into a plurality of page chunks. The inputting module 418 may be configured to input the plurality of page chunks onto the embedding model 407. The embedding model 407 may generate, by utilizing the generating module 420, one vector for each page chunk in response to inputting the plurality of page chunks onto the embedding model 407, wherein each vector represents corresponding text, spatial, and visual feature of the visual document page, i.e., text, position, vision, etc., but the disclosure is not limited thereto.

In some embodiments, the embedding model 407 may be obtained by fine-tuning a pre-trained LLM model through a prompt-generation task. The pre-trained LLM may be an existing pre-trained model. One example of an existing pre-trained model may a comparatively smaller foundation model. Training smaller foundation models may be desirable in the large language model space because it requires far less computing power and resources to test new approaches, validate others' work, and explore new use cases.

Another example of an existing pre-trained model, in some embodiments, may be a foundation model that is a lightweight extension to traditional LLMs for reasoning over visual documents taking into account both textual semantics and spatial layout as disclosed herein. This foundation model may be trained on a large set of unlabeled data, which makes them ideal for fine-tuning for a variety of tasks. This foundation model differs from existing multimodal LLMs by avoiding expensive image encoders and focuses exclusively on bounding box information to incorporate the spatial layout structure.

An embedding may be a vector (list) of floating point numbers. The distance between two vectors may measure their relatedness. For example, small distances may suggest high relatedness and large distances may suggest low relatedness. In some embodiments, to get an embedding, a text string may be sent to embeddings API endpoint along with the embedding model name. The response may contain an embedding (list of floating point numbers), which may be extracted by the extracting module 430, and stored onto a vector database, i.e., database 412.

In some embodiments, the storing module 422 may be configured to store all vectors corresponding to the plurality of the page chunks onto the database 412. The inputting module 418 may be configured to input, in response to receiving a prompt of a query corresponding to the visual document, the vectors of the embedded chunks of pages retrieved from the database 412. The identifying module 424 may be configured to identify most relevant chunks of pages included in the visual document based on the similarities between the query prompt and chucks of pages. The generating module 420 may be configured to generate, in response to inputting the most relevant chunks of pages onto the prompt generation model 409 (i.e., a pre-trained prompt-generation model that utilizes a pre-trained autoregressive LLM), a response to the prompt corresponding to the visual document based on the identified chunks of pages of as context.

In some embodiments, in generating the response to the prompt, the training module 428 may be configured to pre-train the prompt-generation model 409 to generate, by utilizing the generating module 420, query space for each page chunk from the plurality page chunks; capturing, by utilizing the capturing module 426, a semantic essence of the prompt by implementing an alignment learning algorithm utilizing an autoencoder 411 connected to the MRAGM 406 via the communication network 410; and outputting a response to the prompt corresponding to the captured semantic essence given the context of most relevant chunks of pages onto the GUI 436. In some embodiments, the query may include, for example, name of a customer, location of a customer, certain company name, how much money the customer spends on this check, or prompts that require “Yes” or “No” responses, etc., but the disclosure is not limited thereto.

In some embodiments, in fine-tuning the pre-trained prompt-generation model 409, the training module 428 may be configured to: train the prompt-generation model 409 that maximizes log-likelihood of correctly predicting a next token in the sequence of tokens from the prompt, given a context of document page tokens.

In some embodiments, the pre-trained prompt-generation model 409 may also be a pre-trained LLM model as disclosed herein. In some embodiments, the training prompts/queries may be utilized to train/tune the prompt-generation model 409 and the autoencoder 411 as well.

In some embodiments, in capturing the semantic essence of the prompt, MRAGM 406 may be configured to fine-tune the autoencoder 411 to encode the prompt by using contrastive learning objectives and obtain the prompt vector representation of the first special pooling token output from the autoencoder 411 corresponding to the prompt.

In some embodiments, the identifying module 424 may be further configured to identify most relevant chunks included in the visual document based on the vectors by applying a cosine similarity algorithm, wherein a distance between two vectors may measure their relatedness in a manner such that small distances correspond to high relatedness and large distances correspond to low relatedness.

In some embodiments, the ranking module 432 may be configured to rank the most relevant chunks of pages that correspond to high relatedness.

FIG. 5 illustrates an exemplary flow chart of a process 500 implemented by the platform, language, database, and cloud agnostic MRAGM 405 of FIG. 4 for implementing multimodal document artificial AI and LLMs to dynamically and automatically generate contents based on custom data for visual documents thereby preserving spatial and visual features in accordance with an exemplary embodiment. It may be appreciated that the illustrated process 500 and associated steps may be performed in a different order, with illustrated steps omitted, with additional steps added, or with a combination of reordered, combined, omitted, or additional steps.

As illustrated in FIG. 5, at step S502, the process 500 may include receiving, as input, a visual document having a plurality of texts, spatial, and visual features. The visual document may be invoice, contracts, layouts, tables, charts, etc., but the disclosure is not limited thereto.

At step S504, the process 500 may include implementing a page-wise chunking algorithm to chunk the visual document into a plurality of page chunks.

At step S506, the process 500 may include inputting the plurality of page chunks onto a trained embedding model.

At step S508, the process 500 may include generating, by the embedding model, one vector for each page chunk in response to inputting the plurality of page chunks onto the embedding model, wherein each vector represents corresponding text, spatial, and visual feature of each page of the visual document, i.e., text, position, vision, etc., but the disclosure is not limited thereto.

At step S510, the process 500 may include storing all vectors corresponding to the plurality of the page chunks onto a database.

At step S512, the process 500 may include inputting, in response to receiving a prompt of a query corresponding to the visual document, the vectors of the embedded chunks of pages retrieved from the database onto an LLM that utilizes a pre-trained autoregressive language model.

At step S514, the process 500 may include identifying most relevant chunks of pages included in the visual document based on the similarities between the query prompt and chucks of pages.

At step S516, the process 500 may include generating, in response to inputting the most relevant chunks of pages onto the LLM model, a response to the prompt corresponding to the visual document based on identified most relevant chunks of pages.

In some embodiments, in generating the response to the prompt, the process 500 may further include: using the trained prompt-generation model to generate query space for each page chunk from the plurality page chunks; capturing a semantic essence of the prompt by implementing an alignment learning algorithm utilizing an autoencoder; and outputting a response to the prompt corresponding to the captured semantic essence given the context of most relevant chunks of pages. In some embodiments, the query may include, for example, name of a customer, location of a customer, certain company name, how much money the customer spends on this check, or prompts that require “Yes” or “No” responses, etc., but the disclosure is not limited thereto.

In some embodiments, the process 500 may further include: fine-tuning the prompt-generation model by training the LLM that maximizes log-likelihood of correctly predicting a next token in the sequence of tokens from the prompt, given a context of document page tokens.

In some embodiments, in capturing the semantic essence of the prompt, the process 500 may further include: fine-tuning an autoencoder to encode prompt by using contrastive learning objective; and obtaining the prompt vector representation of the first special pooling token output from the autoencoder corresponding to the prompt.

In some embodiments, the process 500 may further include identifying most relevant chunks included in the visual document based on the vectors by applying a cosine similarity algorithm, wherein a distance between two vectors may measure their relatedness in a manner such that small distances correspond to high relatedness and large distances correspond to low relatedness.

In some embodiments, the process 500 may further include ranking most relevant chunks of pages that correspond to high relatedness.

In some embodiments, the MRAGD 402 may include a memory (e.g., a memory 106 as illustrated in FIG. 1) which may be a non-transitory computer readable medium that may be configured to store instructions for implementing a platform, language, database, and cloud agnostic MRAGM 406 for implementing multimodal document artificial AI and LLMs to dynamically and automatically generate contents based on custom data for visual documents thereby preserving spatial and visual features as disclosed herein. The MRAGD 402 may also include a medium reader (e.g., a medium reader 112 as illustrated in FIG. 1) which may be configured to read any one or more sets of instructions, e.g., software, from any of the memories described herein. The instructions, when executed by a processor embedded within the MRAGM 406 or within the MRAGD 402, may be used to perform one or more of the processes as described herein. In a particular embodiment, the instructions may reside completely, or at least partially, within the memory 106, the medium reader 112, and/or the processor 104 (see FIG. 1) during execution by the MRAGD 402.

In some embodiments, the instructions, when executed, may cause a processor embedded within the MRAGM 406 or the MRAGD 402 to perform the following: receiving, as input, a visual document having a plurality of texts, spatial, and visual features; implementing a page-wise chunking algorithm to chunk the visual document into a plurality of page chunks; inputting the plurality of page chunks onto a trained embedding model; generating, by the embedding model, one vector for each page chunk in response to inputting the plurality of page chunks onto the embedding model, wherein each vector represents corresponding text, spatial, and visual feature of each page of the visual document; storing all vectors corresponding to the plurality of the page chunks onto a database; inputting, in response to receiving a prompt of a query corresponding to the visual document, the vectors of the embedded chucks of pages retrieved from the database; identifying most relevant chunks of pages included in the visual document based on the similarities between the query prompt and chucks of pages; and generating, in response to inputting the most relevant chunks of pages onto a generative model, a response to the prompt corresponding to the visual document based on identified most relevant chunks of pages. In some embodiments, the processor may be the same or similar to the processor 104 as illustrated in FIG. 1 or the processor embedded within the MRAGD 202, MRAGD 302, MRAGD 402, and MRAGM 406 which may be the same or similar to the processor 104.

In some embodiments, the generative model may be a prompt generation model that utilizes a pre-trained autoregressive LLM, but the disclosure is not limited thereto.

In some embodiments, in generating the response to the prompt, the instructions, when executed, may cause the processor 104 to further perform the following: using the trained prompt-generation model to generate query space for each page chunk from the plurality page chunks; capturing a semantic essence of the prompt by implementing an alignment learning algorithm utilizing an autoencoder; and outputting a response to the prompt corresponding to the captured semantic essence given the context of most relevant chunks of pages. In some embodiments, the query may include, for example, name of a customer, location of a customer, certain company name, how much money the customer spends on this check, or prompts that require “Yes” or “No” responses, etc., but the disclosure is not limited thereto.

In some embodiments, the instructions, when executed, may cause the processor 104 to further perform the following: fine-tuning the prompt-generation model by training the prompt-generation model that maximizes log-likelihood of correctly predicting a next token in the sequence of tokens from the prompt, given a context of document page tokens.

In some embodiments, in capturing the semantic essence of the prompt, the instructions, when executed, may cause the processor 104 to further perform the following: fine-tuning an autoencoder to encode prompt by using contrastive learning objective; and obtaining the prompt vector representation of the first special pooling token output from the autoencoder corresponding to the prompt.

In some embodiments, the instructions, when executed, may cause the processor 104 to further perform the following: identifying most relevant chunks included in the visual document based on the vectors by applying a cosine similarity algorithm, wherein a distance between two vectors may measure their relatedness in a manner such that small distances correspond to high relatedness and large distances correspond to low relatedness.

In some embodiments, the instructions, when executed, may cause the processor 104 to further perform the following: ranking most relevant chunks of pages that correspond to high relatedness.

In some embodiments as disclosed above in FIGS. 1-5, technical improvements effected by the instant disclosure may include a platform for implementing a platform, language, database, and cloud agnostic multimodal retrieval augmented generation module configured to implement multimodal document artificial AI and LLMs to dynamically and automatically generate contents based on custom data for visual documents thereby preserving spatial and visual features, but the disclosure is not limited thereto.

Although the invention has been described with reference to several exemplary embodiments, it is understood that the words that have been used may be words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, processes, and uses such as are within the scope of the appended claims.

In some embodiments, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that may be capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium may include a solid-state memory such as a memory card or other package that houses one or more non-volatile read-only memories. Further, the computer-readable medium may be a random access memory or other volatile re-writable memory. Additionally, the computer-readable medium may include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards may be periodically superseded by faster or more efficient equivalents having essentially the same functions. Accordingly, replacement standards and protocols having the same or similar functions may be considered equivalents thereof.

The illustrations of the embodiments described herein are intended to provide a general understanding of the various embodiments. The illustrations are not intended to serve as a complete description of all of the elements and features of apparatus and systems that utilize the structures or process described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for multimodal retrieval augmented generation for visual documents having spatial and visual features by utilizing one or more processors along with allocated memory, the method comprising:
receiving, as input, a visual document having a plurality of texts, spatial, and visual features;
implementing a page-wise chunking algorithm to chunk the visual document into a plurality of page chunks;
inputting the plurality of page chunks onto a trained embedding model;
generating, by the embedding model, one vector for each page chunk in response to inputting the plurality of page chunks onto the embedding model, wherein the vector represents corresponding texts, spatial, and visual feature of each page of the visual document;
storing all vectors corresponding to the plurality of the page chunks onto a database;
inputting, in response to receiving a prompt of a query corresponding to the visual document, the vectors of the embedded chucks of pages retrieved from the database;
identifying most relevant chunks of pages included in the visual document based on the similarities between the query prompt and the chucks of pages; and
generating, in response to inputting the most relevant chunks of pages onto a generative model, a response to the prompt corresponding to the visual document based on the identified most relevant chunks of pages.

2. The method according to claim 1, wherein the generative model is a trained prompt generation model that utilizes a pre-trained autoregressive large language model, and wherein in generating the response to the prompt, the method further comprising:
using the trained prompt-generation model to generate query space for each page chunk from the plurality page chunks;
capturing a semantic essence of the prompt by implementing an alignment learning algorithm utilizing an autoencoder; and
outputting a response to the prompt corresponding to the captured semantic essence given the context of most relevant chunks of pages.

3. The method according to claim 2, the method further comprising:
fine-tuning the prompt-generation model by training the prompt-generation model that maximizes log-likelihood of correctly predicting a next token in the sequence of tokens from the prompt, given a context of document page tokens.

4. The method according to claim 2, in capturing the semantic essence of the prompt, the method further comprising:
fine-tuning an autoencoder to encode prompt by using contrastive learning objective; and
obtaining the prompt semantics from a first pooling token output from the autoencoder corresponding to the prompt.

5. The method according to claim 1, further comprising:
identifying most relevant chunks included in the visual document based on the vectors by applying a cosine similarity algorithm.

6. The method according to claim 5, wherein a distance between two vectors measures their relatedness in a manner such that small distances correspond to high relatedness and large distances correspond to low relatedness.

7. The method according to claim 5, the method further comprising:
ranking most relevant chunks of pages that correspond to high relatedness.

8. A system for multimodal retrieval augmented generation for visual documents having spatial and visual features, the system comprising:
a processor; and
a memory operatively connected to the processor via a communication interface, the memory storing computer readable instructions, when executed, causes the processor to:
receive, as input, a visual document having a plurality of texts, spatial, and visual features;
implement a page-wise chunking algorithm to chunk the visual document into a plurality of page chunks;
input the plurality of page chunks onto a trained embedding model;
generate, by the embedding model, one vector for each page chunk in response to inputting the plurality of page chunks onto the embedding model, wherein each vector represents corresponding text, spatial, and visual feature of each page of the visual document;
store all vectors corresponding to the plurality of the page chunks onto a database;
input, in response to receiving a prompt of a query corresponding to the visual document, the vectors of the embedded chucks of pages retrieved from the database;
identify most relevant chunks of pages included in the visual document based on the similarities between the query prompt and the chucks of pages; and
generate, in response to inputting the most relevant chunks of pages onto a generative model, a response to the prompt corresponding to the visual document based on the identified most relevant chunks of pages.

9. The system according to claim 8, wherein the generative model is a trained prompt generation model that utilizes a pre-trained autoregressive large language model, and wherein, in generating the response to the prompt, the processor is further configured to:
use the trained prompt-generation model to generate query space for each page chunk from the plurality page chunks;
capture a semantic essence of the prompt by implementing an alignment learning algorithm utilizing an autoencoder; and
output a response to the prompt corresponding to the captured semantic essence given the context of most relevant chunks of pages.

10. The system according to claim 9, wherein the processor is further configured to:
fine-tune the prompt-generation model by training the prompt-generation model that maximizes log-likelihood of correctly predicting a next token in the sequence of tokens from the prompt, given a context of document page tokens.

11. The system according to claim 9, wherein, in capturing the semantic essence of the prompt, the processor is further configured to:
fine-tune an autoencoder to encode prompt by using contrastive learning objective; and
obtain the prompt semantics from a first pooling token output from the autoencoder corresponding to the prompt.

12. The system according to claim 9, the processor is further configured to:
identify most relevant chunks included in the visual document based on the vectors by applying a cosine similarity algorithm.

13. The system according to claim 12, wherein a distance between two vectors measures their relatedness in a manner such that small distances correspond to high relatedness and large distances correspond to low relatedness.

14. The system according to claim 13, the processor is further configured to:
rank most relevant chunks of pages that correspond to high relatedness.

15. A non-transitory computer readable medium configured to store instructions for multimodal retrieval augmented generation for visual documents having spatial and visual features, the instructions, when executed, cause a processor to perform the following:
receiving, as input, a visual document having a plurality of texts, spatial and visual features;
implementing a page-wise chunking algorithm to chunk the visual document into a plurality of page chunks;
inputting the plurality of page chunks onto a trained embedding model;
generating, by the embedding model, one vector for each page chunk in response to inputting the plurality of page chunks onto the embedding model, wherein each vector represents corresponding text, spatial, and visual feature of each page of the visual document;
storing all vectors corresponding to the plurality of the page chunks onto a database;
inputting, in response to receiving a prompt of a query corresponding to the visual document, the vectors of the embedded chucks of pages retrieved from the database;
identifying most relevant chunks of pages included in the visual document based on the similarities between the query prompt and the chucks of pages; and
generating, in response to inputting the most relevant chunks of pages onto a generative model, a response to the prompt corresponding to the visual document based on the identified most relevant chunks of pages.

16. The non-transitory computer readable medium according to claim 15, wherein the generative model is a trained prompt-generation model that utilizes a pre-trained autoregressive large language model, and wherein, in generating the response to the prompt, the instructions, when executed cause the processor to further perform the following:
using the trained prompt-generation model to generate vectors of query space for each page chunk from the plurality page chunks;
capturing a semantic essence of the prompt by implementing an alignment learning algorithm utilizing an autoencoder; and
outputting a response to the prompt corresponding to the captured semantic essence given the context of most relevant chunks of pages.

17. The non-transitory computer readable medium according to claim 16, wherein the instructions, when executed cause the processor to further perform the following:
fine-tuning the prompt-generation model by training the prompt-generation model that maximizes log-likelihood of correctly predicting a next token in the sequence of tokens from the prompt, given a context of document page tokens.

18. The non-transitory computer readable medium according to claim 16, wherein, in capturing the semantic essence of the prompt, the instructions, when executed cause the processor to further perform the following:
fine-tuning an autoencoder to encode prompt by using contrastive learning objective; and obtaining the prompt semantics from a first pooling token output from the autoencoder corresponding to the prompt.

19. The non-transitory computer readable medium according to claim 15, wherein the instructions, when executed cause the processor to further perform the following:
identifying most relevant chunks included in the visual document based on the vectors by applying a cosine similarity algorithm, wherein a distance between two vectors measures their relatedness in a manner such that small distances correspond to high relatedness and large distances correspond to low relatedness.

20. The non-transitory computer readable medium according to claim 19, wherein the instructions, when executed cause the processor to further perform the following:
ranking most relevant chunks of pages that correspond to high relatedness.
